(19) United States
(12) Patent Application Publication
(10) Pub. No.: US 2025/0067097 A1
(43) Pub. Date: Feb. 27, 2025

(54) PANEL STRUCTURE FOR A HIDDEN WATER TANK

(71) Applicant: Kohler (China) Investment Co., Ltd., Shanghai (CN)

(72) Inventors: Bin Guo, Shanghai (CN); Congxian Huang, Shanghai (CN); Junwen Wang, Shanghai (CN); Bing Dai, Shanghai (CN)

(21) Appl. No.: 18/812,444

(22) Filed: Aug. 22, 2024

(30) Foreign Application Priority Data
Aug. 25, 2023 (CN) 202322307012.6

(51) Int. Cl. E05D 3/02

(52) U.S. Cl. CPC E05D 3/02; E05Y 2900/132

(57) ABSTRACT

A panel structure for a hidden water tank includes: a panel mounting frame configured to be connected to a water tank body; a panel body disposed on an outer side of the panel mounting frame and configured to be opened and closed relative to the panel mounting frame; and a hinge configured to connect a first end of the panel body to the panel mounting frame. A second end of the panel body is connected to the panel mounting frame.

### CROSS REFERENCE TO RELATED APPLICATION

This application claims the benefit of priority to: Chinese Patent Application No. 202322307012.6 filed in the Chinese Intellectual Property Office on Aug. 25, 2023, which is hereby incorporated by reference in its entirety.

### FIELD

The present disclosure relates to the technical field of a panel for a hidden water tank and particularly relates to a panel structure for a hidden water tank.

### BACKGROUND

There is a type of a water tank of a toilet mounted in the wall of the bathroom. The water tank mounted in the wall is referred to as a hidden water tank. A panel is mounted on the wall surface. The panel has an operation mechanism such as a button for opening the valve in the water tank.

The existing panels are fixed to the water tanks by means of buckles, screws, or the like. The entire panel needs to be detached for maintenance, which is inconvenient.

### SUMMARY

The present disclosure aims to overcome the shortcomings in the prior art and provide a panel structure for a hidden water tank. The panel body and the panel mounting frame are connected in a hinged manner and fixed at the end portions in a snap-fit connection. When the maintenance is needed, the panel body is opened and flipped to a certain angle, so that the user may access the water tank in the wall for maintenance. After the maintenance is completed, the panel body may be closed directly. This is convenient for operation.

A technical solution of the present disclosure provides a panel structure for a hidden water tank. The panel structure includes a panel mounting frame configured to be connected to a water tank body. The panel structure also includes a panel body located on an outer side of the panel mounting frame and configured to be flipped to be opened and closed relative to the panel mounting frame.

The panel body is connected to an operation mechanism.

One end of the panel body is connected to the panel mounting frame by means of a hinge, and the other end of the panel body is clamped with the panel mounting frame.

In an embodiment, the panel body is connected to the panel mounting frame by means of two hinges, and the two hinges are arranged at an interval in an up-and-down direction.

In an embodiment, the hinge comprises a first hinge and a second hinge hinged with each other. One end of the first hinge is hinged with the panel mounting frame, and one end of the second hinge is hinged with the panel body.

In an embodiment, an inner side of the panel body is provided with a hinge mounting arm. The hinge mounting arm is provided with an assembly shaft. One end of the second hinge connected to the hinge mounting arm has a first connecting hole, and the assembly shaft is in clearance fit with the first connecting hole.

In an embodiment, the hinge mounting arm is located at a periphery of the operation mechanism.

In an embodiment, an edge of the panel mounting frame is provided with a hinge mounting hole, and one end of the first hinge connected to the panel mounting frame has a first pivot shaft.

The first pivot shaft is in clearance fit with the hinge mounting hole.

In an embodiment, the first hinge includes a first hinge plate, which is provided with a weight reducing hole.

In an embodiment, the second hinge includes two second hinge plates provided in parallel, with a connecting plate connected between the two second hinge plates.

In an embodiment, the connecting plate includes a first connecting plate and a second connecting plate arranged in a crosswise manner, and the first connecting plate and the second connecting plate are connected to the two second hinge plate, respectively.

In an embodiment, the other end of the panel body is provided with a buckle/a slot, and the panel mounting frame is correspondingly provided with a slot/a buckle. The buckle is clamped with the slot.

By adopting the above technical solutions, the present disclosure brings the following beneficial effects.

The panel structure for a hidden water tank according to the present disclosure includes a panel mounting frame and a panel body. The panel mounting frame is configured to connect and fix a water tank body. The panel body is connected to an operation mechanism, and the operation mechanism is configured to operate a valve for opening and closing the water tank. One end of the panel body is connected to the panel mounting frame by means of a hinge, so that the panel body may be flipped to be opened and closed relative to the panel mounting frame. The other end of the panel body is clamped with the panel mounting frame to fix the closed panel body and prevent it from opening automatically.

When maintenance is needed, the panel body is opened and flipped to a certain angle, so that the user may access the water tank in the wall for maintenance. After the maintenance is completed, the panel body may be closed directly. This is convenient for operation.

### BRIEF DESCRIPTION OF THE FIGURES

By reference to the drawings, the contents disclosed by the present disclosure should be more easily understood. It should be understood that: these drawings are merely used for illustration and are not intended to limit the protection scope of the present disclosure. In the drawings:

FIG. 1 is a perspective view of a panel structure according to an embodiment of the present disclosure, with a panel body in an open state;

FIG. 2 is a perspective view of a panel structure according to an embodiment of the present disclosure, with the panel body in a closed state;

FIG. 3 is a perspective view of the panel body;

FIG. 4 is a front view of a panel mounting frame;

FIG. 5 is a sectional view of the panel mounting frame taken along the B-B direction in FIG. 4;

FIG. 6 is an enlarged view of the area A in FIG. 1;

FIG. 7 is a perspective view of a first hinge;

FIG. 8 is a perspective view of a second hinge;

FIG. 9 is a front view of the panel structure mounted on a wall;

FIG. 10 is a perspective view of the panel body on the wall in an open state;

FIG. 11 is an enlarged view of the area C in FIG. 10; and

FIG. 12 is a flow chart of a method for manufacturing a panel structure according to an embodiment of the present disclosure.

### DETAILED DESCRIPTION

The specific embodiments of the present disclosure should be further described by reference to the drawings hereinafter. Same or equivalent parts are denoted by the same reference signs. It should be noted that the terms, such as “front”, “rear”, “left”, “right”, “up”, and “down” used in the present disclosure, refer to the directions in the drawings, and the terms, such as “inner” and “outer”, refer to the directions toward or away from the geometric centers of the specific parts, respectively.

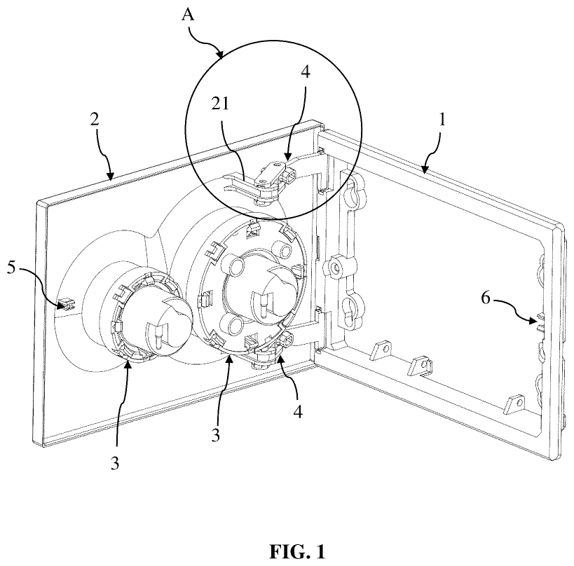

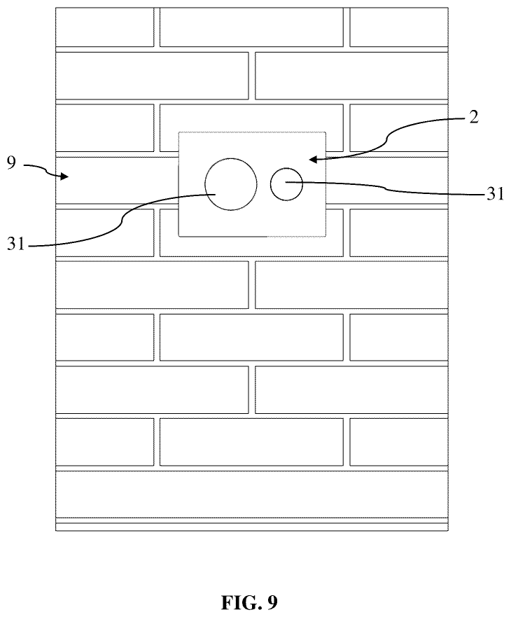

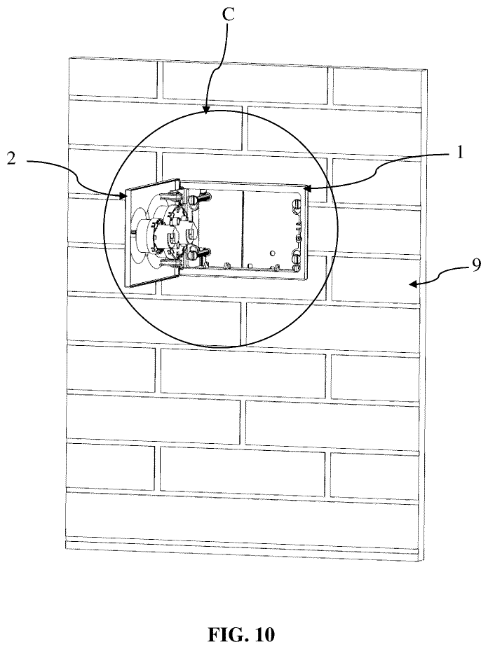

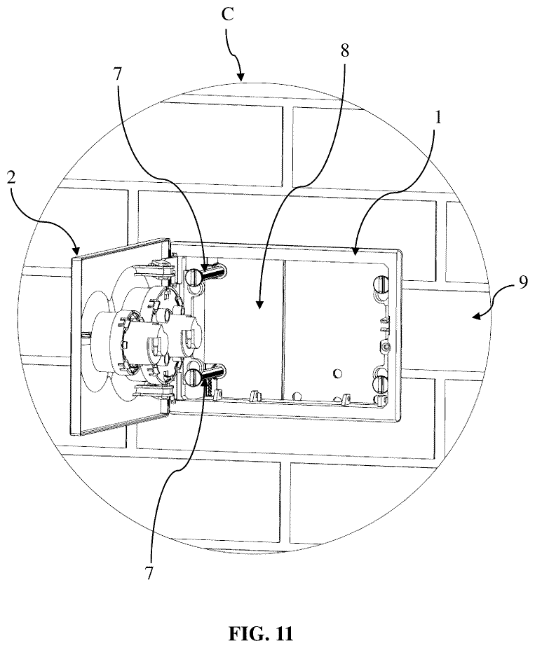

As shown in FIGS. 1, 2, and 9-11, a panel structure for a hidden water tank according to an embodiment of the present disclosure comprises a panel mounting frame 1 configured to be connected to a water tank body 8. The panel structure for the hidden water tank also comprises a panel body 2 located on an outer side of the panel mounting frame 1 and configured to be flipped for being opened and closed relative to the panel mounting frame 1. The “hidden water tank” may be a tank having at least a portion mounted in a wall, a closet, or the like of a bathroom. The panel body 2 is connected to an operation mechanism 3.

One end of the panel body 2 is connected to the panel mounting frame 1 by means of a hinge 4, and the other end of the panel body 2 is clamped with the panel mounting frame 1.

The panel structure according to the present disclosure is used for a hidden water tank, and the panel structure is configured to be connected to a water tank body 8 mounted in a wall 9.

The panel structure comprises a panel mounting frame 1 and a panel body 2. The panel mounting frame 1 is configured to be connected to and fixed with the water tank body 8. Specifically, the panel mounting frame 1 is connected to the water tank body 8 by means of a number of the connecting members 7, which may be bolts, screws, connecting pipes, or the like.

The panel body 2 is mounted with an operation mechanism 3, which comprises a button 31. A user may press the button 31 to trigger a valve in the water tank body 8 via the operation mechanisms 3. If needed, two operation mechanisms 3 may be configured, with one operation mechanism 3 configured to trigger the valve to become fully opened, and the other operation mechanism 3 configured to trigger the valve to become half opened. The description of the structures of and the connection way between the operation mechanisms and the valve has been omitted herein.

The panel body 2 may be flipped to be opened and closed relative to the panel mounting frame 1. Specifically, one end of the panel body 2 is connected to the panel mounting frame 1 by means of the hinges 4, and the other end of the panel body 2 is clamped with the panel mounting frame 1. The one end or the other end of the panel body 2 is not limited to an edge of the panel body 2. The one end or the other end of the panel body 2 may also refer to a portion of the panel mounting frame 1 or a portion of the panel body 2 that is slightly close to the edge. The one end or the other end of the panel body 2 may also refer to one half or the other half of the panel body 2.

One end of the panel body 2 is connected to one end of the panel mounting frame 1 by means of the hinges 4, which may cause the panel body 2 to be flipped to be opened and closed relative to the panel mounting frame 1. The other end of the panel body 2 is clamped with the other end of the panel mounting frame 1 through a snap-fit structure to hold the closed panel body 2 in place, so as to prevent the panel body 2 from being opened automatically. The snap-fit structure may adopt a buckle, a clamp plate, a slot, or the like.

When the maintenance is needed, the user merely needs to slightly pull the clamped end of the panel body 2. The panel body 2 is flipped to be opened to a preset angle (e.g., 90°-110°) and then is stopped. At this point, the user may access the parts in the water tank for the maintenance. After the maintenance is completed, the user rotates the panel body 2 in an opposite direction. The panel body 2 is closed and clamped with the panel mounting frame 1.

In the panel structure according to the present disclosure, the panel body 2 is mounted on the panel mounting frame 1 like a door. This facilitates the operations of opening and closing. There is no need to detach the panel mounting frame 1 and the panel body 2 for the maintenance. This facilitates the maintenance.

In the present disclosure, a hinge refers to an element whose two ends are capable of rotating or swinging. The hinge adopts a structure, such as a connecting plate and a connecting arm.

The hinging involved in the present disclosure refers to a connection structure whose two components may rotate or swing relative to each other. The two components may be connected by means of a pivot shaft to realize the rotating or swinging relative to each other.

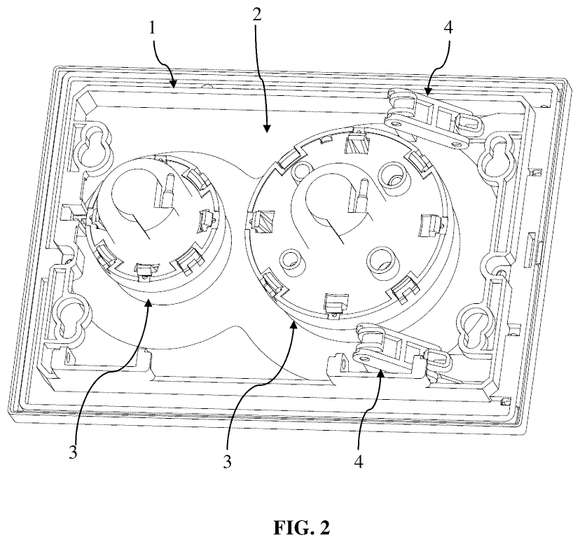

In an embodiment, as shown in FIGS. 1 and 2, the panel body 2 is connected to the panel mounting frame 1 by means of two hinges 4. The two hinges 4 are arranged at an interval (e.g., spaced apart from each other) in an up-and-down direction. This improves the connection stability between the panel body 2 and the panel mounting frame 1.

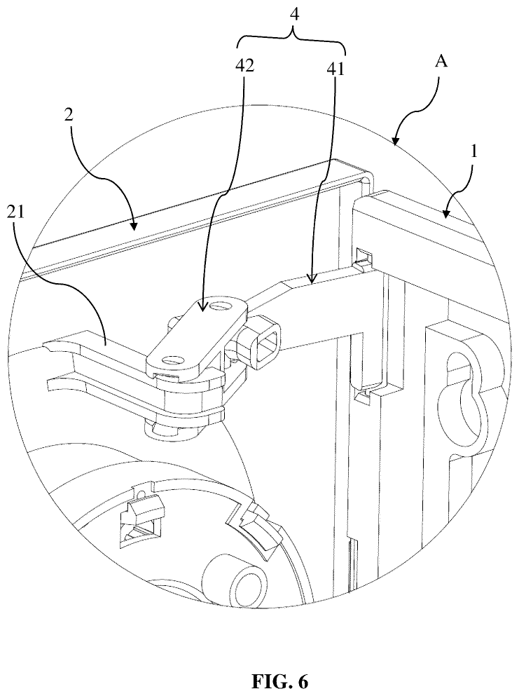

In an embodiment, as shown in FIG. 6, each hinge 4 comprises a first hinge 41 and a second hinge 42 hinged with each other. One end of each first hinge 41 is hinged with the panel mounting frame 1, and one end of each second hinge 42 is hinged with the panel body 2. In this embodiment, each hinge 4 comprises a first hinge 41 and a second hinge 42, which may cause the panel body 2 to be opened at a larger angle. The panel body 2 may also be moved toward the outer side of the wall 9 to increase the space for the maintenance and may facilitate the maintenance for the user.

One end of each first hinge 41 is hinged with the panel mounting frame 1, and the other end of each first hinge 41 is hinged with one end of its corresponding second hinge 42, and one end of each second hinge 42 away from its corresponding first hinge 41 is hinged with the panel body 2.

When the panel body 2 is opened, after one end of each first hinge 41 connected to the panel mounting frame 1 is rotated to be opened at a certain angle, the panel body 2 is pulled toward the outer side of the wall 9. At this time, the second hinges 42 and the first hinges 41 may be opened around the points at which the second hinges 42 and the first hinges 41 are hinged. The panel body 2 moves outwardly by a certain distance. This increases the space available for the user to operate and facilitates the maintenance.

When the panel body 2 is closed, the panel body 2 merely needs to be rotated in an opposite direction. The second hinges 42 and the first hinges 41 may be automatically folded. After the clamped end of the panel body 2 contacts the panel mounting frame 1, it may be clamped by being pressed.

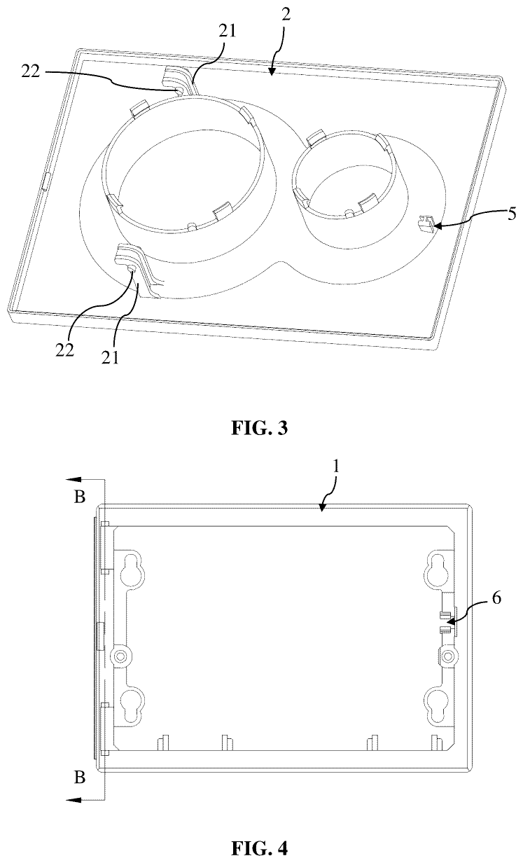

In an embodiment, as shown in FIGS. 3, 6, and 8, the inner sides of the panel body 2 are provided with the hinge mounting arms 21, each of which is provided with an assembly shaft 22. One end of each second hinge 42 connected to its corresponding hinge mounting arm 21 has first connecting holes 422, and each assembly shaft 22 is in clearance fit with (e.g., engaged with or received in) its corresponding first connecting hole 422.

In this embodiment, an inner side of the panel body 2 is provided with the hinge mounting arms 21 configured to mount the second hinges 42, so that each second hinge 42 is spaced apart from the panel body 2 by a certain distance without interference.

Specifically, two opposite sides of the hinge mounting arms 21 are provided with an assembly shaft 22, respectively. One end of each second hinge 42 is provided with first connecting holes 422, and the other end of each second hinge 42 is provided with second connecting holes 423. The assembly shafts 22 pass through their corresponding first connecting holes 422, and the assembly shafts 22 and their corresponding first connecting holes 422 are in clearance fit (e.g., engaged with each other). The second connecting holes 423 are in clearance fit with (e.g., engaged with) their corresponding second pivot shafts 413 on one end of each first hinge 41.

In an embodiment, as shown in FIGS. 2 and 3, the hinge mounting arm 21 is located at the periphery of its corresponding operation mechanism 3. When the panel body 2 is opened, its fulcrum is located in the vicinity of its corresponding operation mechanism 3, so that the operation mechanism 3 is in a position where sufficient space is available. Thus, no interference will occur among the adjacent components.

Generally, the operation mechanism 3 configured to trigger the valve to become fully opened is long, and the hinge mounting arm 21 are desirably arranged in the vicinity of the operation mechanism 3 configured to trigger the valve to become fully opened.

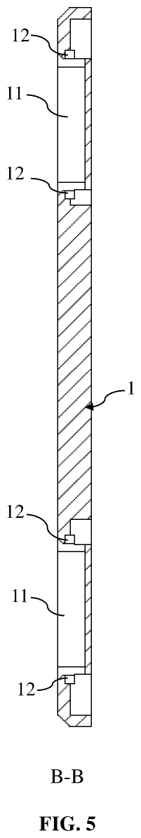

In an embodiment, as shown in FIGS. 4-7, an edge of the panel mounting frame 1 is provided with the hinge mounting holes 12. One end of each first hinge 41 connected to the panel mounting frame 1 has a first pivot shaft 412. The first pivot shafts 412 are in clearance fit with (e.g., engaged with or received in) their corresponding hinge mounting holes 12.

In this embodiment, one end of each first hinge 41 is provided with one first pivot shaft 412, and the other end of each first hinge 41 is provided with one second pivot shaft 413. The upper and lower ends of each first pivot shaft 412 and each second pivot shaft 413 protrude out of (e.g., extend from) the upper and lower sides of the corresponding first hinge 41, respectively.

Recesses 11 are provided at an edge of the panel mounting frame 1. Each of the upper and lower recess walls of each recess 11 is provided with a hinge mounting holes 12. One end of each first hinge 41 having the first pivot shaft 412 is in clearance fit with (e.g., engaged with or received in) its corresponding recess 11. Each first pivot shaft 412 is inserted into its corresponding hinge mounting hole 12, and the first pivot shaft 412 and the hinge mounting hole 12 are in clearance fit (e.g., engaged with each other).

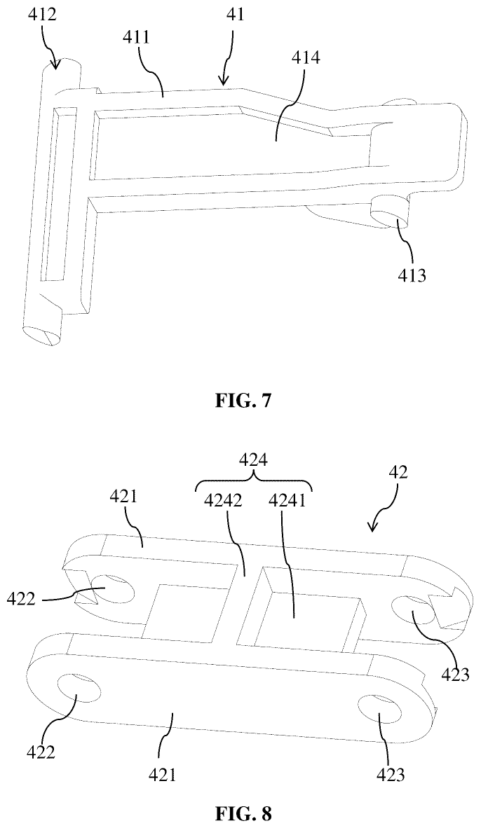

In an embodiment, as shown in FIGS. 6 and 7, each first hinge 41 comprises a first hinge plate 411, which is provided with a weight reducing hole 414 for reducing the weight.

In an embodiment, as shown in FIGS. 6 and 8, each second hinge 42 comprises two second hinge plates 421 provided in parallel, and a connecting plate 424 is connected between the two second hinge plates 421.

In this embodiment, each second hinge 42 comprises two second hinge plates 421 and a connecting plate 424. The two second hinge plates 421 are arranged in parallel, and the connecting plate 424 is connected therebetween. The connecting plate 424 is shorter than the second hinge plates 421, so that a recess is formed at each end of the two second hinge plates 421 and configured to respectively accommodate one end, having the second pivot shaft 413, of the first hinge 41 and one end, having the assembly shaft 22, of the hinge mounting arm 21.

One end of each of the two second hinge plates 421 is provided with a first connecting hole 422, and the other end of each of the two second hinge plates 421 is provided with a second connecting hole 423. The two ends of the assembly shaft 22 are in clearance fit with (e.g., engaged with or received in) the first connecting holes 422 of the two second hinge plates 421, respectively. The two ends of the second pivot shaft 413 are in clearance fit with (e.g., engaged with or received in) the second connecting holes 423 of the two second hinge plates 421, respectively. Such an assembly structure is stable.

In an embodiment, as shown in FIG. 8, each connecting plate 424 comprises a first connecting plate 4241 and a second connecting plate 4242 arranged in a crosswise manner. The first connecting plate 4241 and the second connecting plate 4242 are connected to the two second hinge plates 421, respectively.

In this embodiment, each connecting plate 424 comprises a first connecting plate 4241 and a second connecting plate 4242. The two are arranged in a crosswise manner to reinforce the two second hinge plates 421 from different directions. This is beneficial for improving the structure stability of the second hinges 42.

Desirably, the first connecting plate 4241 and the second connecting plate 4242 are arranged perpendicularly to each other. The first connecting plate 4241 extends along the length direction of the second hinge plates 421, and the second connecting plate 4242 extends along the height direction of the second hinge plates 421.

In an embodiment, as shown in FIGS. 1, 3, and 4, the other end of the panel body 2 is provided with a buckle 5 or a slot 6. The panel mounting frame 1 is correspondingly provided with a slot 6 or a buckle 5, and the buckle 5 is clamped with the slot 6.

In this embodiment, the other end of the panel body 2 and the other end of the panel mounting frame 1 are clamped by means of the slot 6 and the buckle 5.

The buckle 5 and the slot 6 are configured in two ways as below.

In the first configuration way, a buckle 5 is provided at the end of the panel body 2, and a slot 6 is provided at the end of the panel mounting frame 1.

In the second configuration way, a slot 6 is provided at the end of the panel body 2, and a buckle 5 is provided at the end of the panel mounting frame 1.

When the panel body 2 is opened, the user only needs to pull outwardly the end of the panel body 2 having the buckle 5 or the slot 6 to detach the buckle 5 from the slot 6, so as to flip the panel body 2.

After the panel body 2 is closed, the user only needs to press the end of the panel body 2 having the buckle 5 or the slot 6 toward the side of the wall 9. Then, a snap sound is heard, indicating that the buckle 5 is clamped in place with the slot 6.

In an embodiment, a toilet may include a base (e.g., a pedestal, a bowl, etc.) and a tank (e.g., the hidden water tank). The base is configured to be attached to another object such as a drainpipe, floor, or another suitable object. The base includes a bowl, a sump (e.g., a receptacle) disposed below the bowl, and a trapway fluidly connecting the bowl to a drainpipe or sewage line. The tank may be supported by the base, such as an upper surface of a rim. The tank may be integrally formed with the base as a single unitary body. In other embodiments, the tank may be formed separately from the base and coupled (e.g., attached, secured, fastened, connected, etc.) to the base. The toilet may further include a tank lid covering an opening and inner cavity in the tank. The toilet may include a seat assembly including a seat and a seat cover rotatably coupled to the base. The toilet arrangement may further include a hinge assembly.

In another embodiment, the toilet arrangement may be a tankless toilet. The toilet arrangement includes a base and a seat assembly coupled to the base. The base includes a bowl, a sump disposed below the bowl, and a trapway fluidly connecting the bowl to a drainpipe or sewage line. The toilet arrangement includes a waterline that supplies the toilet with water. The toilet may further include a seat assembly including a seat and a seat cover rotatably coupled to the base. The toilets described above are provided herein as non-limiting examples of toilets that may be configured to utilize aspects of the present disclosure.

In some examples, a bidet may be included in a seat or pedestal of a toilet. In other examples, the bidet may be manufactured separately from and attached or coupled to a seat or pedestal of a toilet. The bidet includes a housing. The housing is configured to receive a flow of water through a housing inlet and dispense the flow of water from a housing outlet. The housing inlet and housing outlet may be located on opposite ends of the housing from one another, such that water may flow through the housing from the housing inlet to the housing outlet. In some examples, the housing further includes a chamber. As the housing receives the flow of water, the chamber may fill with water and provide a flow of water between the housing inlet and the housing outlet. The chamber may be configured to contain the flow of water and direct the flow of water from the housing inlet to the housing outlet. After the chamber has filled with water, the flow of water may travel along a substantially linear path between the housing inlet and the housing outlet. In some examples, one or more walls within the housing may be included to help direct a flow of water between the housing inlet and the housing outlet. The bidet may further include a housing inlet conduit configured to direct a flow of water to the housing inlet. The housing inlet conduit may be coupled to a water supply such as tank or waterline. The housing may further include a gear assembly or a portion of the gear assembly. The bidet may be a front wash bidet for female users and may use, generate, and/perform the functions related to nanobubbles, ozonated water, eWater, hydrogen peroxide generation, pH Control, template assisted crystallization, application of polyphosphates, filtration (ultrafiltration, nanofiltration, microfiltration, carbon/GAC), fluidic oscillating sprays, and adding other consumables in the water stream. For nanobubbles, air, ozone, oxygen, hydrogen, and carbon dioxide may be used.

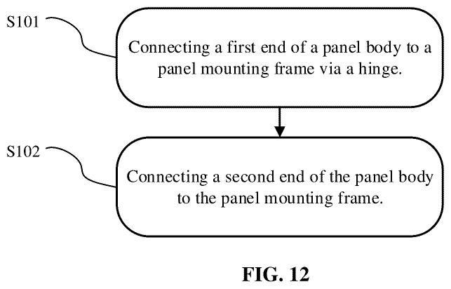

An embodiment of the present disclosure further provides a method for manufacturing a panel structure. FIG. 12 is a flow chart of a method for manufacturing a panel structure according to an embodiment of the present disclosure. The panel structure in the method may be the panel structure according to any of the embodiments, and the descriptions regarding the panel structure are incorporated herein. The panel structure is configured to perform an operation, function, or the like as described in the present disclosure.

At act S101, the first end of the panel body 2 is connected to the panel mounting frame 1 via the hinge 4.

Specifically, as described above, the first hinge 41 of the hinge 4 is connected to the panel mounting frame 1. The first pivot shaft 412 of the first hinge 41 is inserted into the hinge mounting hole 12 of the panel mounting frame 1.

An edge of the panel mounting frame 1 is provided with the hinge mounting holes 12. One end of each first hinge 41 connected to the panel mounting frame 1 has a first pivot shaft 412. The first pivot shafts 412 are in clearance fit with (e.g., engaged with or received in) their corresponding hinge mounting holes 12.

In this embodiment, one end of each first hinge 41 is provided with one first pivot shaft 412, and the other end of each first hinge 41 is provided with one second pivot shaft 413. The upper and lower ends of each first pivot shaft 412 and each second pivot shaft 413 protrude out of (e.g., extend from) the upper and lower sides of the corresponding first hinge 41, respectively.

Recesses 11 are provided at an edge of the panel mounting frame 1. Each of the upper and lower recess walls of each recess 11 is provided with a hinge mounting holes 12. One end of each first hinge 41 having the first pivot shaft 412 is in clearance fit with (e.g., engaged with or received in) its corresponding recess 11. Each first pivot shaft 412 is inserted into its corresponding hinge mounting hole 12, and the first pivot shaft 412 and the hinge mounting hole 12 are in clearance fit (e.g., engaged with each other).

Further, the second hinge 42 of the hinge 4 is connected to the panel body 2. The assembly shaft 22 disposed on the hinge mounting arm 21 of the panel body 2 is inserted into the first connecting hole 422 of the second hinge 42.

In an embodiment, as shown in FIGS. 3, 6, and 8, the inner sides of the panel body 2 are provided with the hinge mounting arms 21, each of which is provided with an assembly shaft 22. One end of each second hinge 42 connected to its corresponding hinge mounting arm 21 has first connecting holes 422, and each assembly shaft 22 is in clearance fit with (e.g., engaged with or received in) its corresponding first connecting hole 422.

In this embodiment, an inner side of the panel body 2 is provided with the hinge mounting arms 21 configured to mount the second hinges 42, so that each second hinge 42 is spaced apart from the panel body 2 by a certain distance without interference.

Further, the first hinge 41 is connected to the second hinge 42. The second pivot shaft 413 of the first hinge 41 is inserted into the second connecting hole 423 of the second hinge 42.

The second connecting holes 423 are in clearance fit with (e.g., engaged with) their corresponding second pivot shafts 413 on one end of each first hinge 41.

In this embodiment, one end of each first hinge 41 is provided with one first pivot shaft 412, and the other end of each first hinge 41 is provided with one second pivot shaft 413. The upper and lower ends of each first pivot shaft 412 and each second pivot shaft 413 protrude out of (e.g., extend from) the upper and lower sides of the corresponding first hinge 41, respectively.

At act S102, the second end of the panel body 2 is connected to the panel mounting frame 1.

Specifically, as described above, the buckle 5 and the slot 6 are configured in two ways as below. In the first configuration way, a buckle 5 is provided at the end of the panel body 2, and a slot 6 is provided at the end of the panel mounting frame 1. In the second configuration way, a slot 6 is provided at the end of the panel body 2, and a buckle 5 is provided at the end of the panel mounting frame 1.

When the panel body 2 is opened, the user only needs to pull outwardly the end of the panel body 2 having the buckle 5 or the slot 6 to detach the buckle 5 from the slot 6, so as to flip the panel body 2.

After the panel body 2 is closed, the user only needs to press the end of the panel body 2 having the buckle 5 or the slot 6 toward the side of the wall 9. Then, a snap sound is heard, indicating that the buckle 5 is clamped in place with the slot 6.

The above technical solutions may be combined as required to achieve the best technical effect.

The above are merely the principle and the embodiments of the present disclosure. It should be pointed out that, for those having ordinary skill in the art, several other variations may be made on the basis of the principle of the present disclosure, which should also be regarded as falling in the protection scope of the present disclosure.

1-10. (canceled)

11. A panel structure for a hidden water tank, the panel structure comprising:
a panel mounting frame configured to be connected to a water tank body;
a panel body disposed on an outer side of the panel mounting frame and configured to be opened and closed relative to the panel mounting frame; and
a hinge configured to connect a first end of the panel body to the panel mounting frame,
wherein a second end of the panel body is connected to the panel mounting frame.

12. The panel structure for the water tank according to claim 11, wherein the panel body is configured to be connected to the panel mounting frame via two hinges, and
wherein the two hinges are spaced apart from each other in an up-and-down direction of the panel body.

13. The panel structure for the hidden water tank according to claim 11, wherein the hinge comprises:
a first hinge configured to be hinged with the panel mounting frame; and
a second hinge configured to be hinged with the first hinge and the panel body.

14. The panel structure for the water tank according to claim 13, wherein the panel body comprises:
a hinge mounting arm disposed on an inner side of the panel body; and
an assembly shaft configured to connect the hinge mounting arm to the second hinge, and
wherein the second hinge comprises a first connecting hole configured to receive the assembly shaft.

15. The panel structure for the hidden water tank according to claim 13, wherein the first hinge comprises a first pivot shaft configured to connect the first hinge to the panel mounting frame,
wherein the panel mounting frame comprises a hinge mounting hole configured to receive the first pivot shaft.

16. The panel structure for the hidden water tank according to claim 13, wherein the first hinge comprises a second pivot shaft configured to be connected to the second hinge, and
wherein the second hinge comprises a second connecting hole configured to receive the second pivot shaft.

17. The panel structure for the hidden water tank according to claim 13, wherein the first hinge comprises a first hinge plate, and
wherein the first hinge plate comprises a weight reducing.

18. The panel structure for the water tank according to claim 13, wherein the second hinge comprises:
two second hinge plates arranged in parallel; and
a connecting plate configured to be connected between the two second hinge plates.

19. The panel structure for the hidden water tank according to claim 18, wherein the connecting plate is shorter than the two second hinge plates.

20. The panel structure for the hidden water tank according to claim 19, wherein the panel body comprises an assembly shaft configured to connect the panel body to the second hinge,
wherein the first hinge comprises a second pivot shaft configured to be connected to the second hinge, and
wherein the second hinge comprises:
two first connecting holes respectively disposed on a first end of the two second hinge plates and configured to receive the assembly shaft; and
two second connecting holes respectively disposed on a second end of the two second hinge plates and configured to receive the second pivot shaft.

21. The panel structure for the hidden water tank according to claim 20, wherein the connecting plate comprises a first connecting plate and a second connecting plate both configured to be connected to the two second hinge plates.

22. The panel structure for the hidden water tank according to claim 21, wherein the first connecting plate is perpendicular to the second connecting plate.

23. The panel structure for the hidden water tank according to claim 22, wherein the first connecting plate extends along a length direction of the two second hinge plates, and
wherein the second connecting plate extends along a height direction of the two second hinge plates.

24. The panel structure for the hidden water tank according to claim 11, further comprising:
a buckle disposed on the second end of the panel body; and
a slot disposed on the panel mounting frame configured to be clamped with the buckle.

25. The panel structure for the hidden water tank according to claim 11, further comprising:
a slot disposed on the second end of the panel body; and
a buckle disposed on the panel mounting frame configured to be clamped with the slot.

26. The panel structure for the hidden water tank according to claim 14, further comprising:
an operation mechanism configured to be connected to the panel body and configured to trigger a valve for opening and closing the water tank body; and
wherein the hinge mounting arm is disposed at a periphery of the operation mechanism.

27. A hidden water tank, comprising:
a water tank body;
a valve disposed in the water tank body and configured to open and close the water tank body; and
a panel structure comprising:
a panel mounting frame configured to be connected to the water tank body;
a panel body disposed on an outer side of the panel mounting frame and configured to be opened and closed relative to the panel mounting frame;
a hinge configured to connect a first end of the panel body to the panel mounting frame; and
an operation mechanism configured to be connected to the panel body and configured to trigger the valve for opening and closing the water tank body,
wherein a second end of the panel body is connected to the panel mounting frame.

28. The hidden water tank according to claim 27, wherein the operation mechanism comprises:
a first operation mechanism configured to fully open the valve; and
a second operation mechanism configured to half open the valve, and
wherein each of the first operation mechanism and the second operation mechanism comprises a button.

29. A method for manufacturing a panel structure for a hidden water tank, the method comprising:
connecting a first end of a panel body to a panel mounting frame via a hinge; and
connecting a second end of the panel body to the panel mounting frame,
wherein the panel body is disposed on an outer side of the panel mounting frame and configured to be opened and closed relative to the panel mounting frame.

30. The method for manufacturing the panel structure for the hidden water tank according to claim 29, wherein connecting the first end of the panel body to the panel mounting frame via the hinge comprises:
connecting a first hinge of the hinge to the panel mounting frame;
connecting a second hinge of the hinge to the panel body; and
connecting the first hinge to the second hinge,
wherein connecting the first hinge of the hinge to the panel mounting frame comprises:
inserting a first pivot shaft of the first hinge into a hinge mounting hole of the panel mounting frame,
wherein connecting the second hinge of the hinge to the panel body comprises:
inserting an assembly shaft disposed on a hinge mounting arm of the panel body into a first connecting hole of the second hinge,
wherein connecting the first hinge to the second hinge comprises:
inserting a second pivot shaft of the first hinge into a second connecting hole of the second hinge, and
wherein connecting the second end of the panel body to the panel mounting frame comprises:
clamping a buckle disposed on the second end of the panel body with a slot disposed on the panel mounting frame; or
clamping a buckle disposed on the panel mounting frame with a slot disposed on the second end of the panel body.
